(19) United States
(12) Patent Application Publication
(10) Pub. No.: US 2026/0030698 A1
(43) Pub. Date: Jan. 29, 2026

(54) SYSTEM AND PROCESS FOR COORDINATING A REAL ESTATE CLOSING

(71) Applicant: Jessica FINGLETON, East Hampton, NY (US)

(72) Inventor: Jessica FINGLETON, East Hampton, NY (US)

(21) Appl. No.: 18/781,909

(22) Filed: Jul. 23, 2024

(51) Int. Cl. G06Q 50/16; G06Q 10/0631; G06Q 30/018; G06Q 30/0601

(52) U.S. Cl. CPC G06Q 50/167; G06Q 10/063114; G06Q 30/018; G06Q 30/0609

(57) ABSTRACT

There is a process for guiding at least two parties in a real estate closing over a computer network having at least one microprocessor comprising the steps of registering at least one first party by storing information about the first and the second party in the computer network, next there is registering at least one buyer and then registering at least one offer on at least one house. Next, the process includes creating an offer listing by presenting the offer listing over a computer network, next automatically setting deadlines for each party for production of documents, and then tracking the receipt of documents for timeliness by tracking the time the documents are presented into the computer network and then ranking at least one of the parties based upon the documents presented based upon timeliness and quality of the documents.

### CROSS REFERENCE TO RELATED APPLICATIONS

### Background of the Invention

The invention relates to a process for tracking and guiding a process for a house or real estate closing using a computerized network. This process can also be used for general projects or contract work and negotiations as well. In the past, when two real estate brokers wished to engage in a house closing with their clients as well as attorneys involved in the closing, the closing process could become chaotic. Inexperienced, intractable, disorganized or overworked homeowners, buyers, brokers or attorneys could fail to produce the correct documents or fail to produce the correct documents in a timely manner thereby leading to delays in closings. Therefore, there is a need for a process which can be used to guide these parties to a more efficient process and solution.

### SUMMARY

There is a process for guiding at least two parties in a real estate closing over a computer network having at least one microprocessor comprising the steps of registering at least one first party by storing information about the first and the second party in the computer network, next there is registering at least one buyer and then registering at least one offer on at least one house. Next, the process includes creating an offer listing by presenting the offer listing over a computer network, next automatically setting deadlines for each party for production of documents, and then tracking the receipt of documents for timeliness by tracking the time the documents are presented into the computer network and then ranking at least one of the parties based upon the documents presented based upon timeliness and quality of the documents.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a view of a flow chart for the process for tracking a closing process of a house;

FIG. 2 is a block diagram of a network for tracking a closing process of a house;

FIG. 3A is a block diagram of a server or computer on the network;

FIG. 3B is a block diagram of a portable electronic device such as a cellular telephone on the network;

FIG. 4 is a flow chart for the computerized process for engaging in a closing between two brokers;

FIG. 5 is a flow chart for ranking brokers engaging in the computerized process;

FIG. 6 is a chart for categorizing the type of response provided by brokers;

FIG. 7 is a view of a chart for ranking the brokers;

FIG. 8A is a view of a scale for allowing additional time for response to requests for documents based upon broker rankings;

FIG. 8B is a view of the scale for a grace period after the response deadline;

FIG. 9 is a view of an inter-office task/job board;

FIG. 10 is a view of an educational system which leads to points added to each party/user; and

FIG. 11 is a view of the rankings of the attorneys, brokers and brokerage houses.

### DETAILED DESCRIPTION

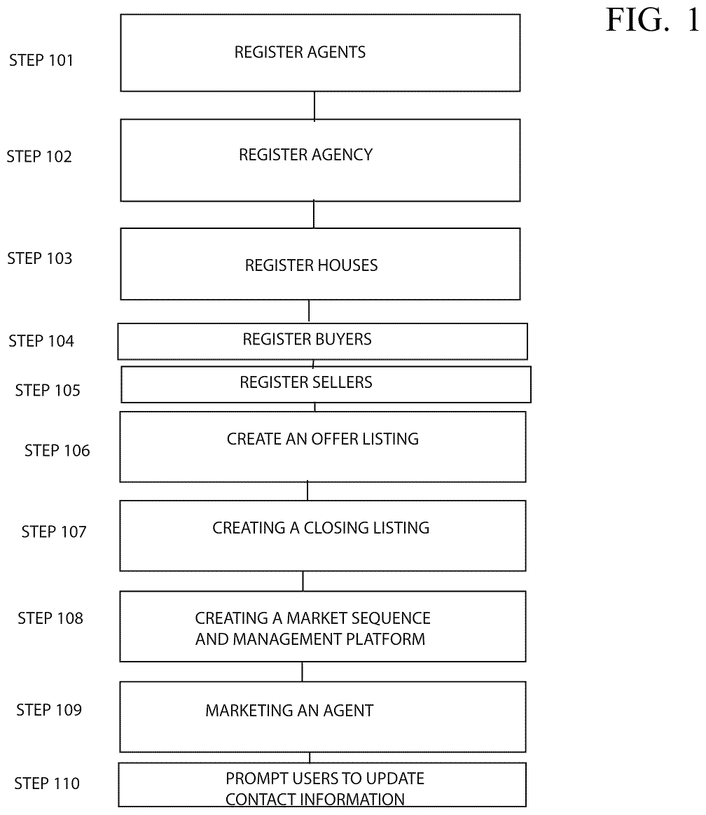

FIG. 1 is a view of a flow chart for the process for tracking the closing process of a house. In the first step, the system can register the agents. Real estate agents/brokers are usually associated with a particular brokerage house as well. In this step, the agents/brokers input their information such as name, address, brokerage house, contact information, pictures (if any), as well as any registration numbers or licenses. The agents/brokers can also insert their hours of work or number of past closings if they are working towards any particular certification which requires proof of experience before any final certification. This information is input into a computer such as computer 130 or into a portable electronic device 140 such as a cell phone or smart phone device. The information is first processed by an application server 110 and then also processed and stored in a database server 120 in associated database tables.

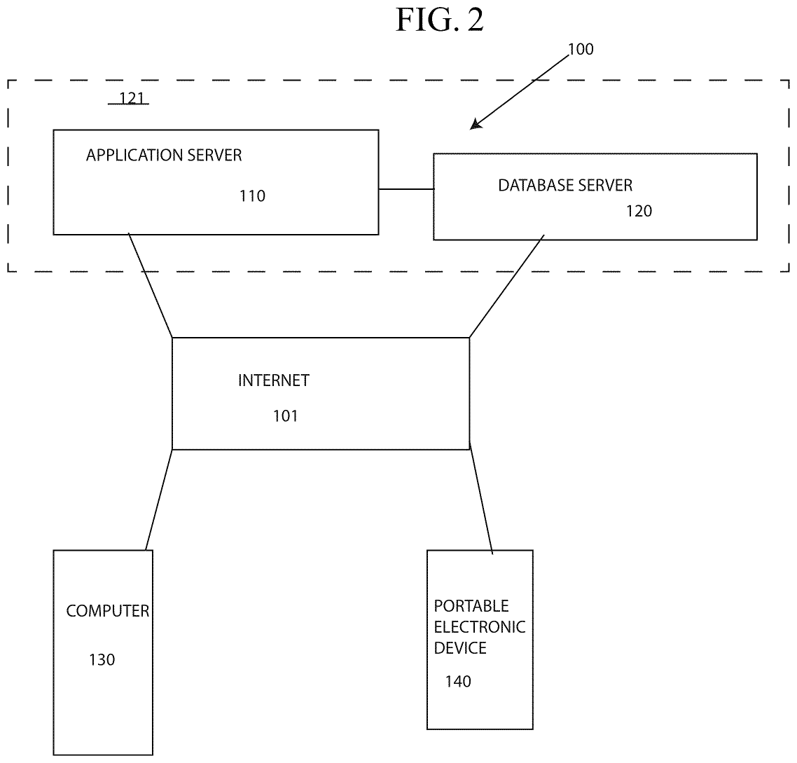

Similarly in step 102 the users can register a brokerage agency in the system as well. For example, the users can register a brokerage agency in the system by inputting the address of the brokerage agency and the organizational structure of the agency. As indicated above, this information is input via either computer 130 and/or portable electronic device 140 wherein the information is then stored first in application server 110 and then ultimately stored in database server 120 (See FIG. 2). In step 103 the users can register any house with the system. The information relating to the house includes the address, any pictures, a disclosure of the square footage of the house, the plot plan (if available), a name of a listing broker, pictures, property details including but not limited to number of bedrooms, bathrooms, any dimensions, a summary write up, name of school district, a listing of the taxes costs, purchase price, a listing of the property history (previous purchases etc.). As indicated above this process includes uploading this information through either a remote computer 130 or through a portable electronic device 140. This information is then uploaded through application server 110 wherein the information is then stored in database server 120.

Next, in step 104 the system can allow for the registering of buyers into the system. The buyers would be the purchasers of the real estate. The registration of these buyers would likely be by the agent(s) or broker(s) in the system, so that the buyer of the real estate would be linked with either the agent or the broker in the system.

Similarly, in step 105, the system allows for the registration of the sellers in the system. This registration of the sellers in the system can also be either via the brokers or the agents in the system. In this way the sellers are tied with either the brokers and/or the agents in the system so that other brokers and/or agents do not try to poach or steal the other registered buyers or sellers in the system.

Next, in step 106 the system or a user can create an offer listing. The offer listing includes the set price and terms for purchase. The offer listing includes publishing the home for sale on the system.

Next, in step 107 the system can create a closing listing. The closing listing is triggered either before or after an actual offer is at least initially accepted. The closing listing is created by application server 110 which is then stored in database server 120.

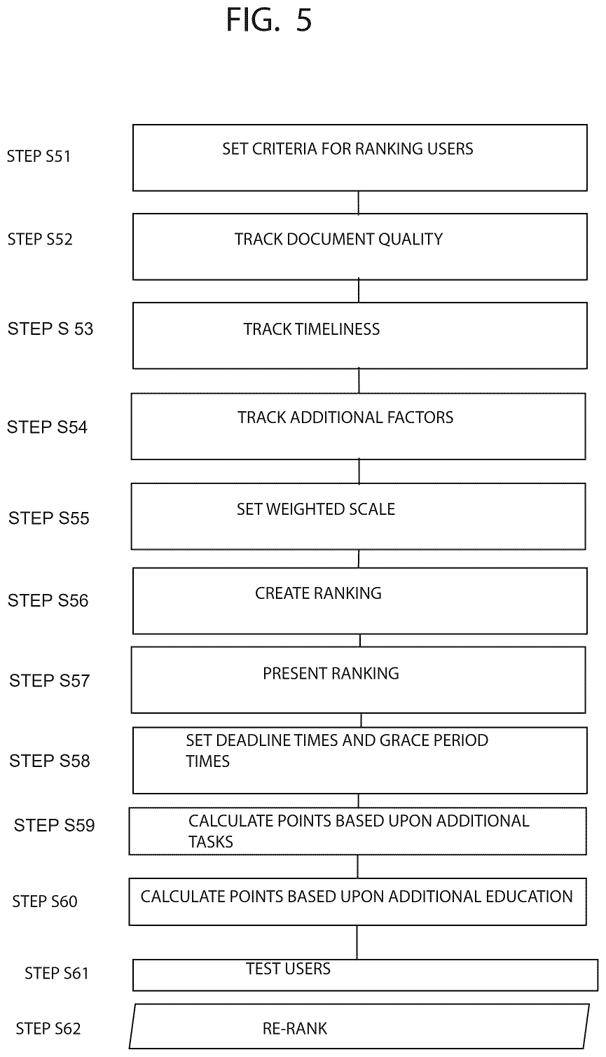

Next, the application server 110 in step 108 then creates a market sequence and management platform by setting forth the documents required for the closing, the scheduling of each of the steps of the closing and the order of the documents to be presented in the closing. This information, including the documents required, the order in which the documents are to be presented is then stored in the database server 120 as well. Next, in step 109, the system can then market and rank a particular agent. For example, the agent/broker who has input his/her information could then be graded or judged for proficiency. FIGS. 5-8 detail the process for ranking the agent/broker when utilizing the system as well.

In addition, in step 110 the system can prompt users to update their contact information. This prompt for users to update their contact information can come as a periodic reminder generated internally in the system, or generated by a request from another user such as a request from an agent, a broker, an attorney, or any other party prompting other users to input their contact information.

FIG. 2 is a block diagram of a network for tracking a closing process of a house and for ranking the broker/agent when using the system. For example, FIG. 2 shows system 100 which includes internet 101, an application server 110, and a database server 120. Coupled to the system is also a computer 130 and/or a portable electronic device 140. This portable electronic device can include at least one cell phone or smart phone. The database server 120 and the application server can communicate directly with each other either across the internet or behind a single firewall in a localized intranet. In addition, this application server 110 can be housed in the same physical server as the database server 120 as well so that a single actual server 121 can optionally house both the application server 110 and/or the database server 120.

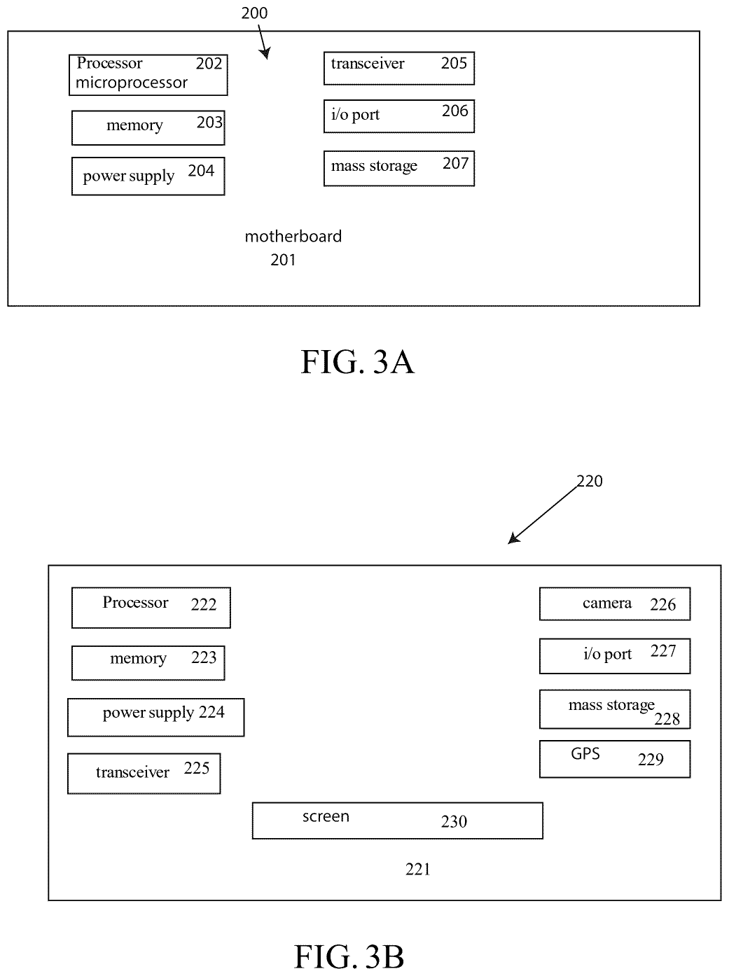

FIG. 3A is a block diagram of a server 200 which can be any one of servers 110, 121, 120 or computer 130 on system or network 100. This view shows a motherboard 201 which houses a processor/microprocessor 202, a memory 203, a power supply 204, a transceiver 205, an I/O port 206 and a mass storage device 207 as well. Power supply 204 provides power to the remaining components on the motherboard through the motherboard bus. The processor/microprocessor 202 is programmed to perform the steps outlined in FIGS. 1, 4, and 5. The computer software which is stored in memory 203 is then periodically uploaded to processor/microprocessor 202 so that server 200 is configured to perform the steps outlined in FIGS. 1, 4, 5.

FIG. 3B is a block diagram of a portable electronic device such as a cellular telephone on the network. For example, device 220 includes a motherboard 221 which houses a processor 222, a memory 223, a power supply 224, a transceiver 225, a camera 226, an i/o port 227, a mass storage device 228, a GPS 229 and a screen 230. The processor 222 is configured to run any of the steps outlined in FIGS. 1, 4, and 5 or to coordinate with the server such as server 200 to help perform the steps of FIGS. 1, 4 and 5. The processor 222 draws information from memory 223 such as a program or application of instructions so that the processor 222 can then carry out the steps of the program. The power supply 224 can then be used to provide power to

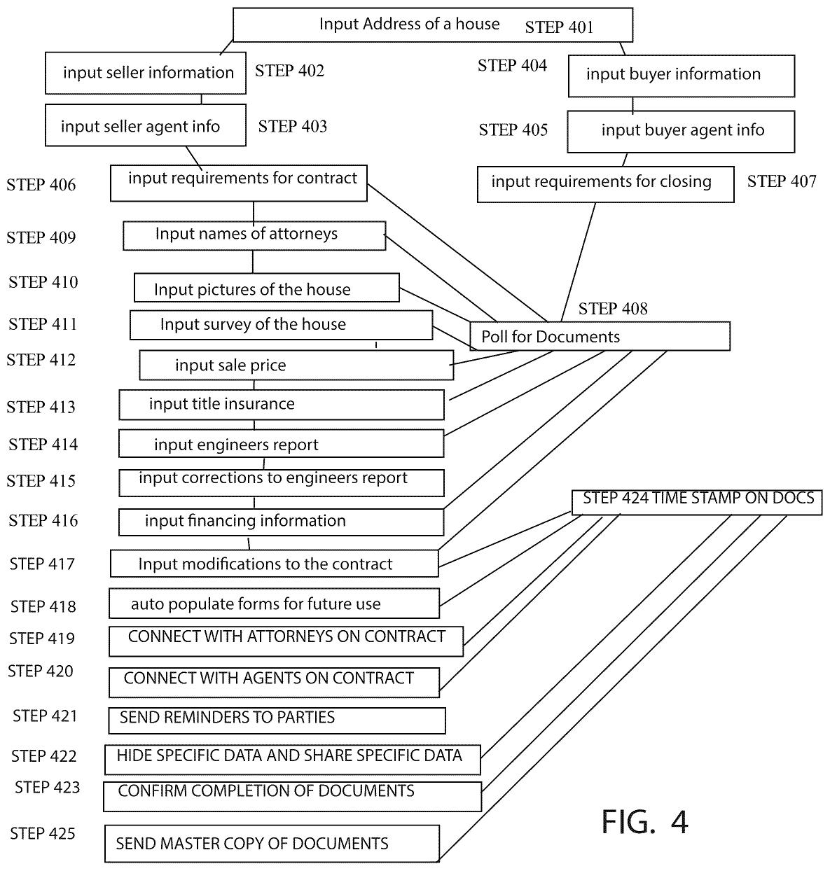

FIG. 4 is a flow chart for the computerized process for engaging in a closing between two brokers. For example, the process begins in step 401 wherein the user can input the address of a house. The input of the address of the house can then result in the creation of a whole house profile. Next in step 402 the user can input seller information. This information can be in the form of the name, address, correspondence information for the seller. Next, in step 403, the seller agent information can be input in again as well. The agent information can be in the form of name, mailing address, correspondence information, brokerage house, picture. If there is a transaction or sales history for the agent, this information can be posted/imported as well. Next, in step 404 the user can input the buyer information as well. The buyer information can be in the form of name, address, correspondence information including mailing address, email address, phone number etc. Next, in step 405 the user can also input the agent information for the buyer as well. This agent's information can be in the form of mailing address, name, email address, brokerage house, picture, as well as a transaction or sales history as well. This information can also include the picture of the buyer broker as well. Next, in step 406 the user can input the requirements for the contract. The requirements for the contract can cause a trigger in the system to require certain documents to be presented in a certain formatted process. The required information for the contract can include the sale price, the identity of the house, including the plot map and/or the specifics of the house. It can also include the closing date, the parties to the contract, including the attorneys (step 409) to the contract, the brokers on the contract, the buyer's name, the seller's name, the requirement for title insurance, proof of mortgage pre-approval, as well as any additional contract requirements. In addition to the requirements for the contract, in step 407, the user can input the requirements for the closing as well. Once the requirements for the closing are input the system can set up the timetable and form in which the requirements for the contract and the requirements for the closing are met. The timetable can be set by the date for execution of the contract as well as the timetable for the date of closing of the sale. Next, in step 408, the system can poll documents. The polling for documents can include polling for more information on the names of the attorneys in the contract/closing in step 409. This information can include the names of the attorneys, the names of the firms associated with the attorneys, the correspondence information, any dates or expected delays from the attorneys, or other parties. The polling for documents can request and/or require the presentation of pictures of the house in step 410. Next, in step 411 the polling can require the survey of the house to be input into the system.

Next, the polling for information can include requesting the sale price in step 412. Next, the polling for information can require the title insurance in step 413. Next, the polling for information can include requiring the engineers report in step 414. Next, in step 416 the polling can require the input of financing information into the system. Next, in step 417 the users can input modifications to the contract as created by the previous entries, including the required corrections to the house as required by the engineer's report. These required corrections can also be offset by a reduction in the sales price as negotiated by each of the attorneys. Each one of these modifications and final inputs into the contract can be stamped in step 424 so that there is a time stamp on the final submission of data into the system. In that way each broker, buyer, seller, brokerage house, and attorney or other party to the contract would have their information time stamped into the system to verify the exact time that this final set of information is put into the system. Next, in step 418 the information that is put into the system can be used to auto populate forms in the future so that any additional forms that are put into the system can be automatically filled in with appropriate information when the situation is appropriate. This auto population feature can occur at any step wherein once the information is available in the system this data can then be used to auto-populate the forms.

Next, in step 419 the system can connect with the attorneys associated with the contract. Next, in step 420 the system can connect with the agents or other brokerage houses on the contract so that updates to the information can be relayed to the appropriate parties. In addition, with the system having a communications connection between the attorneys, the brokers and the brokerage houses this encourages all parties to submit all of their information in a timely manner. This can occur via regular reminders in step 421 to each party to submit any additional information into the system. Next, in step 422 the system can be interacted with so that the party that submits the information can redact or control which information is relayed to certain parties. Therefore, each party inputting information can hide specific data and share other data with other parties. This can be done on an information-by-information basis and on a party-by-party basis. Next, in step 423 the system can confirm the completion of each of the documents and then where appropriate place a time stamp on each of these completed documents in step 424. This time stamp process can be used for any time that a broker, agent, buyer, seller, attorney or other participant submits either a signed contract, or inputs data, or agrees to a term of a contract. In that way each of the negotiated steps is cataloged for its timeliness. That way each participant is tracked for their timeliness in the system.

Next, in step 425 the system can send master copies of the documents to the appropriate parties.

FIG. 5 is a flow chart for ranking brokers engaging in the computerized process. This process can start in step S51 wherein the system can set the criteria for ranking the brokers. This criteria in step S51 can include both the quality of documents as well as the timeliness of the documents. Next, in step S52 the system can track the document quality. The document quality can be whether the document is 1) complete, 2) is of sufficient quality to pass visual recognition; 3) is organized and in order; 4) is authenticated wherein authentication can be whether the document has an official seal or warranty. Next, in step S53 the system can track the timeliness of the presentation of the documents. The tracking of the timeliness of the documents can be based upon whether the documents arrived earlier than required or if the documents arrive later than required, the system can set the level of penalty for the delay of the presentation of the document(s).

Next, the system can track in step S54, any additional factors for controlling the documents such as additional features or requirements that can be placed on the documents. The additional factors can include additional ratings for customer service, and professionalism. Next, in step S55 the system can set a weighted scale for each of the above categories. For example, timeliness can be weighted higher than the quality of the documents. For example, the weighting can be on a factor of 3 points for timeliness, 2 points for quality of the documents, and 1 point for additional factors. Alternatively, the weighting of these characteristics could be even for each of these factors such as a 1:1:1 scale. Alternatively, the scale can be on the scale of 1:2:1 (timeliness:quality of documents:additional factors). While these different weighting scales are shown, any suitable alternatives can be used.

In addition, while the importance of each of these categories can be weighed, the different qualities of each of these categories can also be weighed. For example, if a document is late, there can be different penalties depending on the deadline, the time past the deadline and the importance of the document and/or deadline. For example, if the engineers report is late in delivery, the first set of overdue dates (such as first week overdue) could issue a 2-point penalty, if that first extension period is missed then the penalty could double to 4 points for the second week of delay for example. Each of the deadlines can be set with overdue points penalties in such a manner. For example, if the title insurance is delayed in delivery, the penalty can be 1 point for the first week of delay, 2 points for a second week of delay and so on. Each document that is delivered can have a pre-set weight of importance and weight of penalty based upon either pre-set levels of penalties or based upon customized penalties based upon agreements by the users.

Next, in step S56, the ranking of each of the participants can be created based upon past behaviors including the past deadlines met as well as the quality of the documents and any other additional factors (see step s54).

Next, in step S57, the system can present the ranking of each of the parties such as brokers, buyers, sellers, and attorneys.

Next, in step S58 the deadlines, timelines and grace period timelines can be re-set to set the new types of deadlines and due dates for each of the participants.

This step may become important if a particular participant had unusual circumstances which held that participant up from meeting a deadline. An example of an unusual circumstance could be a death in the family, a hold up in federal, state or local government services, a national pandemic, or as a result of the actions of other participants which could lead to a delay.

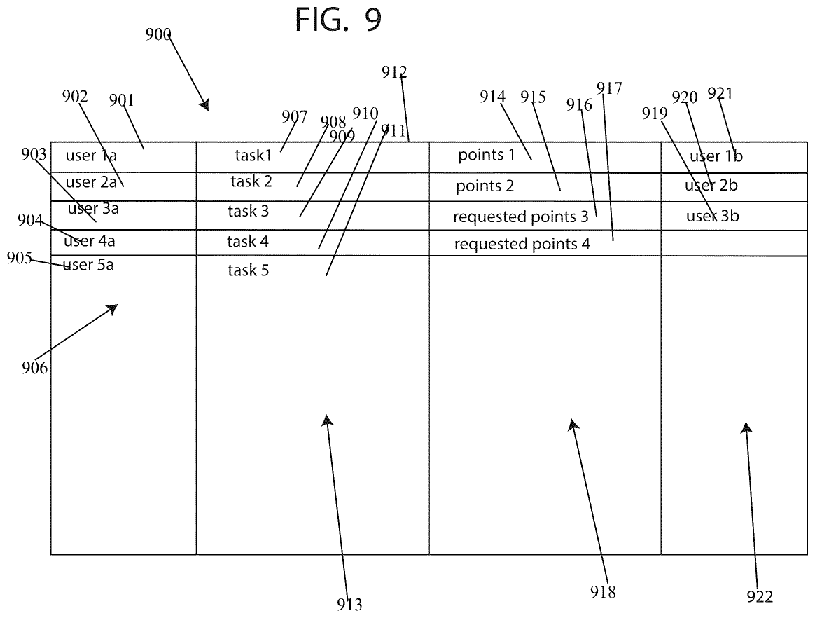

If the re-set of the deadlines and due dates is agreed upon by each of the parties for a past event, then these points can be applied to the actions of an existing user. In addition, in step S59, if a user such as a broker, agent, attorney or other user of the system performs additional tasks working for another user of the system, that original user would then be given additional points based upon the tasks and the quality of the tasks performed. These points can be awarded as payment by the requesting user for services performed. (See FIG. 9)

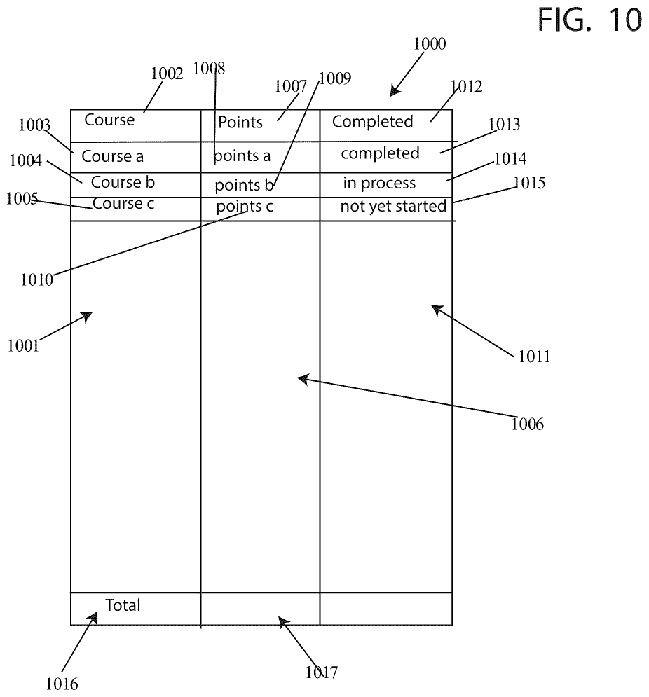

Next, in step S60 the system can calculate the number of points based upon the additional education attained by the user (See FIG. 10).

Next, in step S61, the system can test the users to make sure that they have basic knowledge of the system before using the system. Thus, even owners of properties who have attained enough points through education and testing can list their properties directly on the system without having to hire another user such as an additional broker.

Then in step S62 the system can re-rank the participants based upon an adjustment of the deadlines, and grace period times as well as the penalties attributed to each of these events and/or tasks as well as education attained.

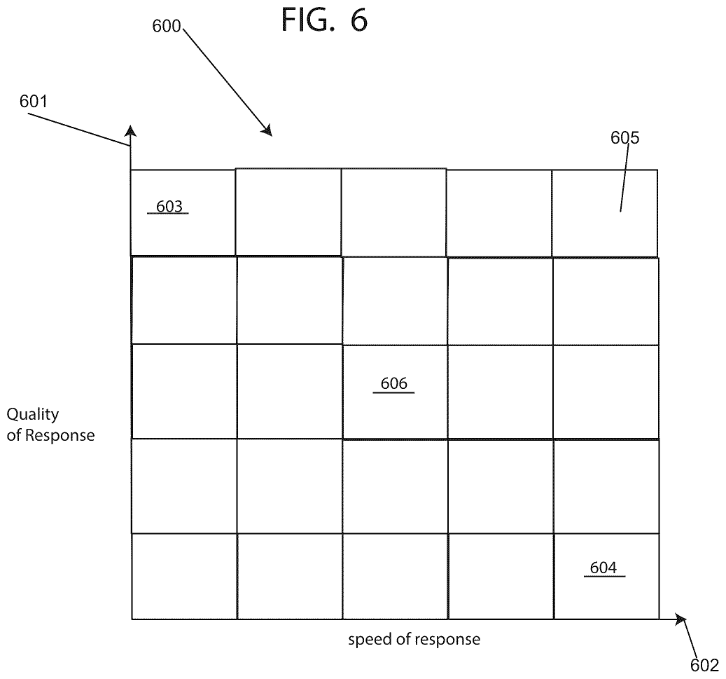

FIG. 6 is a chart for categorizing the type of response provided by brokers. In this view, this is for assigning a total set of points for each response based upon both timeliness and the quality of the response. The quality of the response can be a rating based upon both objective factors and subjective factors. The objective factors can be determined based upon the clarity of the document (number of imperfections in the scanned document), whether the document is authenticated (such as notarized) or apostilled, or other form of third-party verification, or simply whether the document satisfies the requirement for the response. The higher the quality of the response, the higher in the matrix along the axis 601 is the placement of the response. In addition, with respect to the speed of the response, the faster the response, the closer to the origin on the matrix is the response. Therefore, a high quality and fast response would be in the top left box of the matrix or in box 603, a lower quality of the response and slower response would be lower on the matrix and farther to the right. Thus, the best score for the response would be the top left box 603, while the worst score would be the bottom right box 604 on the matrix adjacent to the axis 602. All other responses would fall somewhere in between. An example of a score in between would be in box 606.

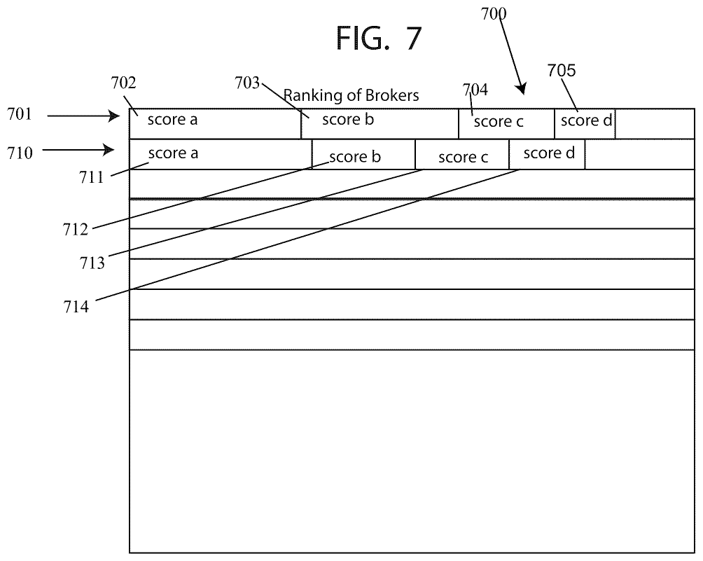

FIG. 7 is a view of a chart for ranking the users such as brokers/attorneys or other participants. For example, chart 700 includes a first user 701. In this view, user 701 is provided with a first score 702 on a document which can be taken as a combined score of both timeliness and quality of the document (See matrix 600 FIG. 6). Next, score b (reference numeral 703) can be a score for submitting a second document, taken from the score provided by matrix 600 (see FIG. 6). Next score 6c (reference numeral 704 can be for the submission of a third document, and score d (reference numeral 705 can be for the submission of a fourth document. All of these scores are then tallied together to provide a final score for the user 701. The better the score for the user, the higher the ranking. Similarly, a second user 710 is ranked based upon a combination of scores a, b, c, and d, as shown by sections 711, 712, 713, and 714 respectively. Each of these sections represent the different scores for each of the documents submitted during a particular period between contract and closing on a home. The scores are created by the combination of the quality of the document submitted, the timeliness of the submission as well as any additional factors (See step S54).

Depending on the rankings of the users, the system can automatically pre-set the time periods for response to the documents, as well as the grace periods and extension times and penalties for submitting the documents.

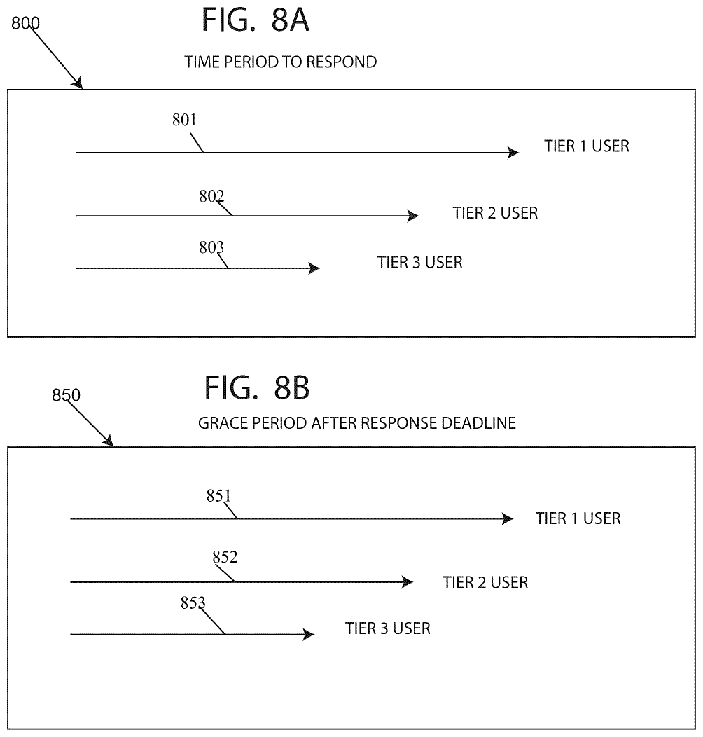

For example, FIG. 8A is a view of a scale for allowing additional time for response to requests for documents based upon user (broker, attorney, owner/buyer) rankings. For example, FIG. 8A shows the pre-set time periods for response to a requirement to submit documents. A tier 1 user would be one who has a high ranking and is one who would have the longest period of time for submission of a particular document. A tier 2 user would be one who has a lower ranking below the tier 1 user and thus a shorter time 802 for submission of documents. A tier 3 user would be one who has a lower ranking than the tier 1 user, or a tier 2 user, and would have the shortest period of time 803 to submit these documents.

FIG. 8B shows chart 850 for the grace period for the different users. The grace period would be calculated as the period of time after the deadline before any penalties set in. Alternatively, the grace period would be a first period for which a first penalty would set in. For a tier 1 user the time period for the grace period shown as time 851 would be longer than the time period for the other grace periods. As shown for the tier 2 user, the time period for the grace period 852 would be shorter than the time period 851. Also, the time period 853 which is for the tier 3 user would be shorter than the time period for the tier 2 user or the tier 1 user.

FIG. 9 is a system for allocating tasks between users of the system. In this way the system can be in the form of a brokerage system wherein there is a clearing house listing of tasks and points allocated or bid on which are associated with each of these tasks. For example, the system 900 can include a board 912 having a first column 906 of users including a first user 901, a second user 902, a third user 903, a fourth user 904, and a fifth user 905. Each of these users 901-905 can post a task or job in column 913 on the job board 912. These jobs can include jobs or tasks 907, 908, 909, 910, 911 associated with each of the users 901-905. Each of these users can then post points that are allocated on the board in column 918. In this way points listing 914 is associated with task 1 907 which is associated with user 1a 901. Points 915 is associated with task 908 which is associated with user 902. Points 916 is associated with task 909, which is associated with user 903. Points 917 is associated with task 910, which is associated with user 904. A corresponding user can bid on these tasks and accept these tasks as shown in column 922. For example, a user 921 is shown as having accepted points 914 for task 907, while user 920 is shown as having accepted points 915 for task 908, while user 919 is shown as bidding on or negotiating points 916 for task 909, when the number of points is accepted by each party the term “requested points” can then change to simply points as shown by points 915. Thus, board 912 creates a clearing house for allocating jobs or tasks among users. These tasks can be in the form of staging an open house, hosting an open house, passing out flyers, making phone calls, mailings etc. Any suitable task that would be in furtherance of a closing can be posted on board 912. Once the task is performed to the satisfaction of a user such as user 901, those points are then awarded to the user conducting the task such as user 921.

FIG. 10 shows a screen 1000 which outlines a series of courses 1002-1005 in a chart wherein this chart has a first column 1001 having header 1002 showing courses 1003, 1004, 1005 which are each associated with points in a column 1006 showing header 1007 indicating points 1008, 1009, 1010, associated with their adjacent courses (courses 1003-1005 respectively). The other column 1011 shows whether these courses have been completed via column header 1012 showing that course 1003 has been completed via designation 1013 course 1004 is still in process 1014, while course 1005 has not yet been started. Row 1016 shows the total of points earned by each user for taking these courses in section 1017 (see Step S60 in FIG. 5).

Thus, depending on the rankings the different users can have longer and/or shorter periods of time to respond, as well as optionally longer periods of time for a grace period for responding to document submission.

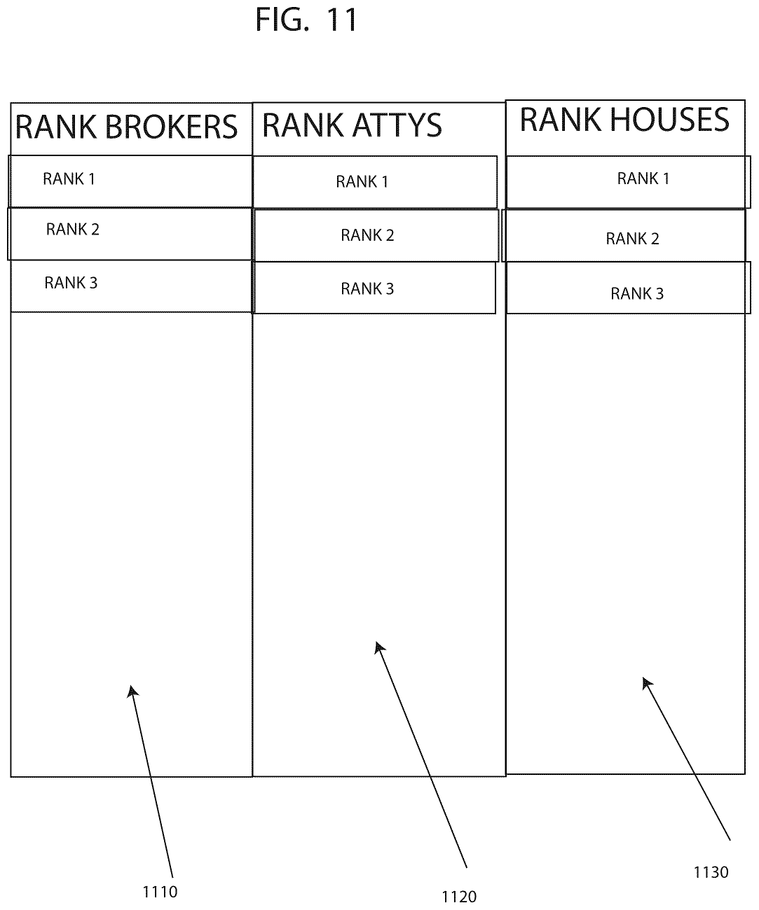

FIG. 11 is a view of the rankings of the different parties. For example, there is shown the ranking of brokers 1110, ranking of attorneys 1120 and the ranking of brokerage houses 1130. Thus, depending on the level and ranking, each of the ranked parties may have a longer period to respond, greater penalties for a late response or a shorter grace period if the party is late in responding to a request. Therefore, there is created an automated system which is configured to help move all parties forward in an orderly manner towards a real estate contract and closure of a real estate transaction.

Accordingly, while at least one embodiment of the present invention have been shown and described, it Is to be understood that many changes and modifications may be made thereunto without departing from the spirit and scope of the invention as defined in the appended claims.

What is claimed is:

1. A process for guiding at least two parties in a real estate closing over a computer network having at least one microprocessor comprising the following steps:
a) registering at least one first party by storing information about the first party in the computer network;
b) registering at least one second party by storing information about the first party in the computer network;
c) registering at least one buyer by storing information about the first party in the computer network;
d) registering at least one offer by storing the offer in the computer network;
e) registering at least one house by storing information on the house on the computer network;
f) creating an offer listing by presenting the offer listing over a computer network;
g) automatically setting deadlines using a microprocessor pre-setting the deadlines for each party for production of documents;
h) track receipt of documents for timeliness by tracking the time the documents are presented into the computer network; and
i) rank at least one of the parties based upon the documents presented.

2. The process as in claim 1, further comprising the step of determining the quality of documents presented by receiving a rating from at least one party of the quality of the document.

3. The process as in claim 1, further comprising the step of providing a matrix for determining the quality and timeliness of the documents being submitted.

4. The process as in claim 4, wherein the matrix has pre-set boxes for determining the points assigned to the documents being submitted on behalf of the user.

5. The process as in claim 1, further comprising setting a sequence for the order of submission of documents.

6. The process as in claim 1, further comprising the step of setting a series of reminders for reminding users of when the documents are to be submitted.

7. The process as in claim 1, further comprising the step of pre-setting the deadlines for each party to submit documents.

8. The process as in claim 7, further comprising the step of pre-setting the grace period for each deadline for each party to submit documents.

9. The process as in claim 1, further comprising the step of setting additional factors for rating the submission of documents.

10. The process as in claim 9, wherein the additional factors include at least one of client satisfaction, courtesy, and responsiveness.

11. The process as in claim 1, further comprising ranking at least one user based upon the points assessment for submission of documents.

12. The process as in claim 11, further comprising setting pre-set tiers for each user.

13. The process as in claim 12, further comprising setting the deadlines for at least one user based upon the tier for each user.

14. The process as in claim 13, further comprising setting the grace period deadlines for each user based upon the tier for each user.
